(19) United States
(12) Patent Application Publication
(10) Pub. No.: US 2006/0059483 A1
(43) Pub. Date: Mar. 16, 2006

(54) Pull scheduling of software components in hard real-time systems

(76) Inventors: Albertina De Bunje, Eindhoven (NL); Simon Tony Dekker, Hilversum (NL)

Correspondence Address: PHILIPS INTELLECTUAL PROPERTY & STANDARDS, P.O. BOX 3001, BRIARCLIFF MANOR, NY, 10510, US

(21) Appl. No.: 10/537,064

(22) PCT Filed: Oct. 31, 2003
(86) PCT No.: PCT/IB03/04938

§ 371 Date: Jun. 1, 2005

(30) Foreign Application Priority Data
Dec. 3, 2002 (EP) 02080058.7

(51) Int. Cl. G06F 9/46

(52) U.S. Cl. 718/100

(57) ABSTRACT

The present invention relates to a method of determining when a component is schedulable in a hard real time system for processing time dependent streams of data elements. The number of components is larger than the number of available processors for processing said components, and each of the components have at least one input and at least one output. The components are scheduled by determining the earliest time on which a component can contribute to the output of the system and by scheduling the component that can contribute to the output at the earliest time. The invention also relates to a hard real time system for processing time dependent streams of data elements with means for performing the above scheduling.

The invention relates to a method of scheduling components in a hard real time system for processing time dependent streams of data elements. The invention further relates to a hard real time system for processing time dependent streams of data elements.

In real-time software systems where the number of components is greater than the number of available processors, components compete for processing time, and scheduling of components is required reliably and fast. In the present context, any software system in which the time, at which an output is produced is essential, is referred to as a real-time software system. The lag from the input time of a real-time software system to its output time, i.e. the delay, must be sufficiently small for acceptable timeliness. A hard real-time software system has to respond to an externally generated input within a bounded time interval. A software system in the present context is typically constructed from a number of interconnected components and the only interaction between components is through their interfaces, components do not share state information.

In this kind of system, a scheduler assigns processing intervals to the components in such a way that the real-time constraints on system level are met. The scheduling of components consists of two phases that are repeated continuously over time. First, the set of schedulable components is determined and then, from this set and according to some prioritization scheme, a subset of components is selected that will actually be executed on the processors (one component is executed on each processor).

A number of prioritization schemes is known.
Round Robin Scheme—A snapshot is made of the set of schedulable components. This set is arbitrarily ordered and the components are selected one by one. After all schedulable components are served, the set of schedulable components is updated.
Fixed Priority Scheme—Each component will have a certain fixed priority. From the set of schedulable components the component with the highest priority is chosen. Next, the set of schedulable components is updated, and from this new set the component with the highest priority is chosen, and so on.
Flexible Priority Scheme—Each component will get a priority that might change over time. From the set of schedulable components the component is chosen with the highest priority at that time. Next, the set of schedulable components is updated and the priorities of the components are re-computed. From this new set, the component with the highest priority is chosen, and so on.
Priority-based Pre-emptive Scheduling—This approach to scheduling can be combined with fixed or flexible priorities. When a component with higher priority becomes schedulable during the processing of a component with a lower priority, the processing of the latter component can be interrupted to serve the component with a higher priority first.
Pipeline or Push Scheduling—The sources of the directed graph of components are arbitrarily ordered. The schedulable sources are treated one by one, but after each step the schedulable set is updated, and the data is pushed as far as possible through the graph. When no component can be scheduled anymore due to the processing of the source, the next schedulable source is treated.

The problem considered here is to find an effective prioritization scheme that makes an optimal choice of a schedulable component from the set of schedulable components. By optimal is meant a minimal port-to-port delay.

U.S. 2002/0062435 describes a multi-streaming processor with a multiple of streams for processing a multiple of threads, and an instruction scheduler with a priority record of priority codes for one or more of the streams. The priority codes determine in some embodiments relative access to resources as well as which stream has access at any point in time. In other embodiments, priorities are determined dynamically and altered on-the-fly, which may be done by various criteria, such as on-chip processing statistics, by executing one or more priority algorithms, by input from an off-chip according to stream loading, or by combinations of these.

U.S. Pat. No. 6,195,701 describes a method for synchronization and scheduling of multiple data streams and real time tasks. A schedule criterion is determined by a trigger condition, e.g. in terms of the state of the streaming processes. Such state is then again related to time marks of the streams and the system time. This document does not solve the problem of executing streaming and control of streaming using one processor by performing scheduling of components.

Meanwhile, it is found that the above-described data handling does not comply with the highest output rate available for a system. Prior art may typically allocate processing resources available to data next in a data queue. That means if two data streams assigned with equal processing priority in a processing pipeline await processing resources, the data stream first in line is processed as the first. This may in some applications be inconvenient, as a processing operation in a processing tree structure may be locked for a considerable amount of time before output is generated. This inconvenience may escalate considerably with the depth of the processing tree.

It is an object of the invention to provide a method for scheduling, suitable for achieving hard real time operation of a system and solving the problems mentioned above.

This is obtained by a method of scheduling schedulable components in a hard real time system for processing time dependent streams of data elements, where the number of schedulable components is larger than the number of available processors for processing said components and where each of said components have at least one input and one output characterized in that the method comprises the steps of consecutively:
determining for each schedulable component the earliest time on which said component can contribute to the output of said hard real time system,
scheduling the schedulable component that can contribute to the output of said real time system at the total earliest time.

This implies that no processing time is spent to schedulable components that do not contribute to the production of output, if there are schedulable components that do contribute to the output.

In an embodiment scheduling of said number of components is performed using push scheduling, if a number of schedulable components contribute to the output of said real time system at the same total earliest time. Push scheduling introduces less context switches in this case than other ways of scheduling. Minimizing context switches also supports low port-to-port delays.

In another embodiment a length of a predefined time interval is specified for each component and a component is schedulable when time stamped data elements from a predefined time interval of said time dependent stream of time stamped data element is available at all inputs of said component. Combination with timebox-scheduling allows for determining the earliest contribution to output in a way, which is easy to re-compute.

In a specific embodiment the availability of said predefined time interval of said time stamped data elements is determined by defining a begin time and an end time of said predefined time interval and checking when the time, until which data has been processed by a preceding component, is newer than the end time of said predefined time interval. This allows for an easy way to check if a component is schedulable.

In an embodiment the step of determining the earliest time, on which said component can contribute to the output, is performed by:
identifying possible paths of subsequent components that the data elements have to be processed by in order to reach the output of said system from said component,
determining an earliest contribution time for each possible path by subtracting from the begin time of said predefined time interval, the length of each of the predefined time intervals specified for each of said subsequent components in said path.
determining the earliest time on which said component can contribute to the output as the earliest determined contribution time.

This is a way to define ‘earliest contribution’ in a way that does not give preference to any output, or any path to reach an output.

In a specific embodiment the step of determining the earliest time on which said component can contribute to the output is performed by:
identifying a path of subsequent components that the data elements have to be processed by in order to reach the output of said system from said component,
determining an earliest contribution time for each possible path by subtracting from the begin time of said predefined time interval, the length of each of the predefined time intervals specified for each of said subsequent components in said path, where at least some of said predefined time intervals have been subtracted a displacement value.
selecting the earliest time on which said component can contribute to the output as the earliest determined contribution time.

This allows for an easy way to decide which schedulable component can contribute to an output at the earliest point in time, in case displacements are used to force the data flow through the system.

The invention also relates to a hard real time system for processing time dependent streams of data elements, said system comprising a number of components and a number of processors for processing components, said number of components is larger than the number of processors, each of said components having at least one input and at least one output, said system comprises means for determining for each schedulable component the earliest time on which said component can contribute to the output of said hard real time system, and means for scheduling the schedulable component that can contribute to the output of said real time system at the total earliest time.

The present invention can be used in real-time systems such as, video and audio processing systems in the processed (MPEG2, MPEG4) and unprocessed domain. Further real-time system could be image processing, image recognition, industrial automation, pattern recognition and radar and telecommunication.

In the following, preferred embodiments of the invention will be described referring to the figures, wherein

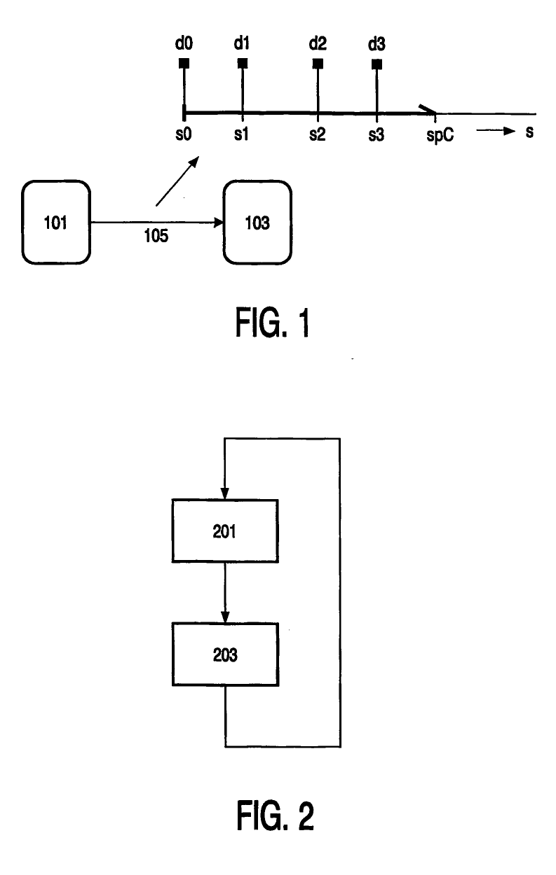

FIG. 1 illustrates a connector between two components,

FIG. 2 illustrates in general steps the process of defining scheduleability of components and executing a scheduled component,

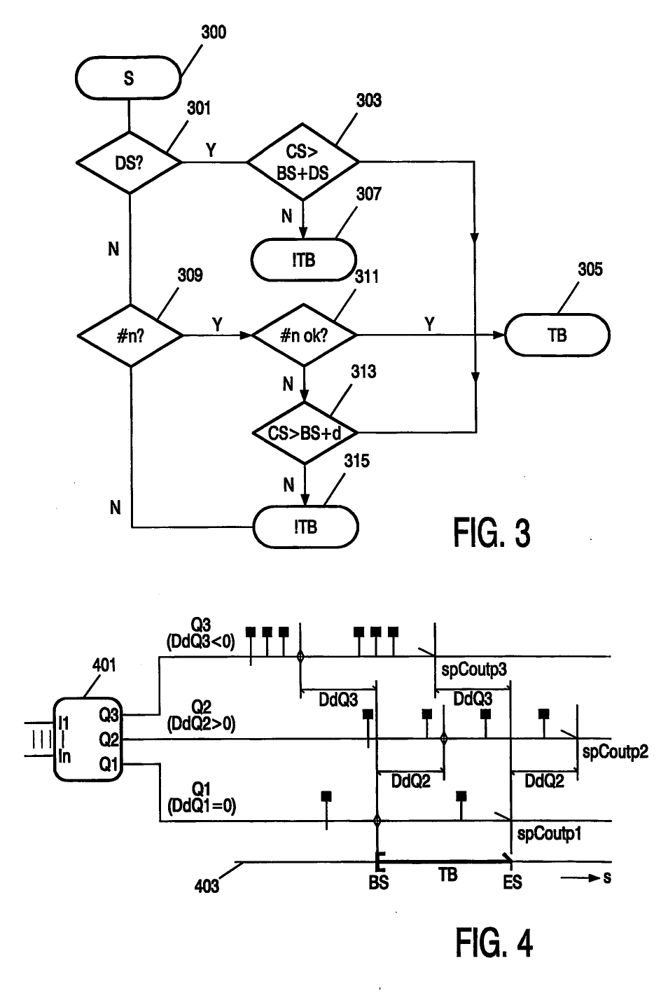

FIG. 3 is a flow diagram illustrating how it is decided whether it is possible to assign a current time box for a specific component,

FIG. 4 illustrates displacement of the current time box for each connector,

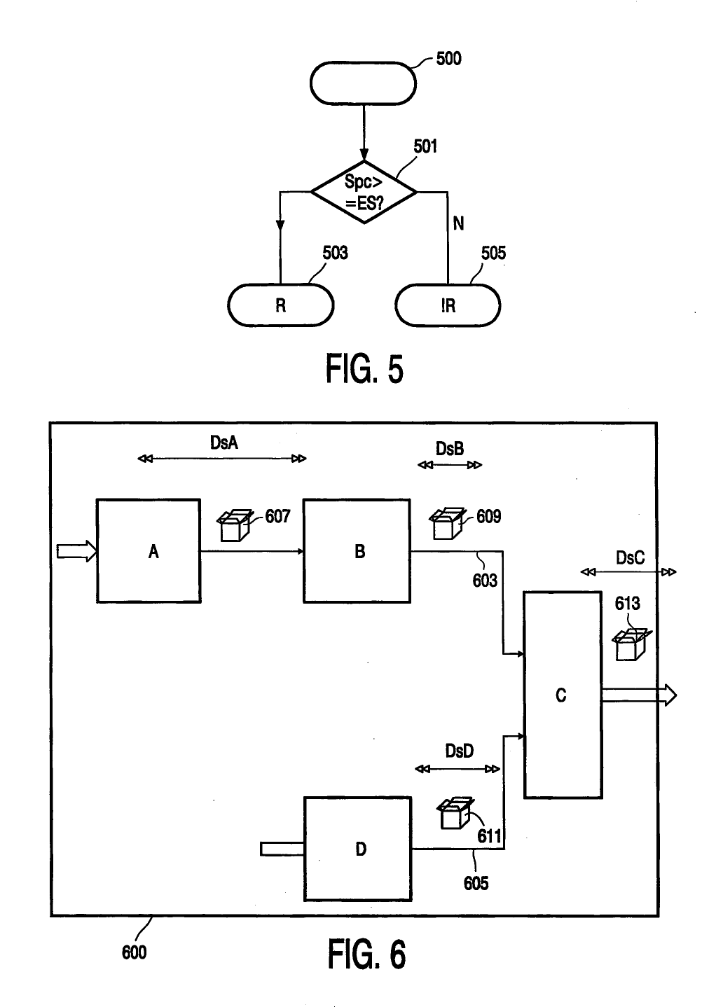

FIG. 5 illustrates how the scheduler uses the time-boxes when determining scheduleability of components,

FIG. 6 illustrates a hard real time system being used for explaining the scheduling of schedulable components,

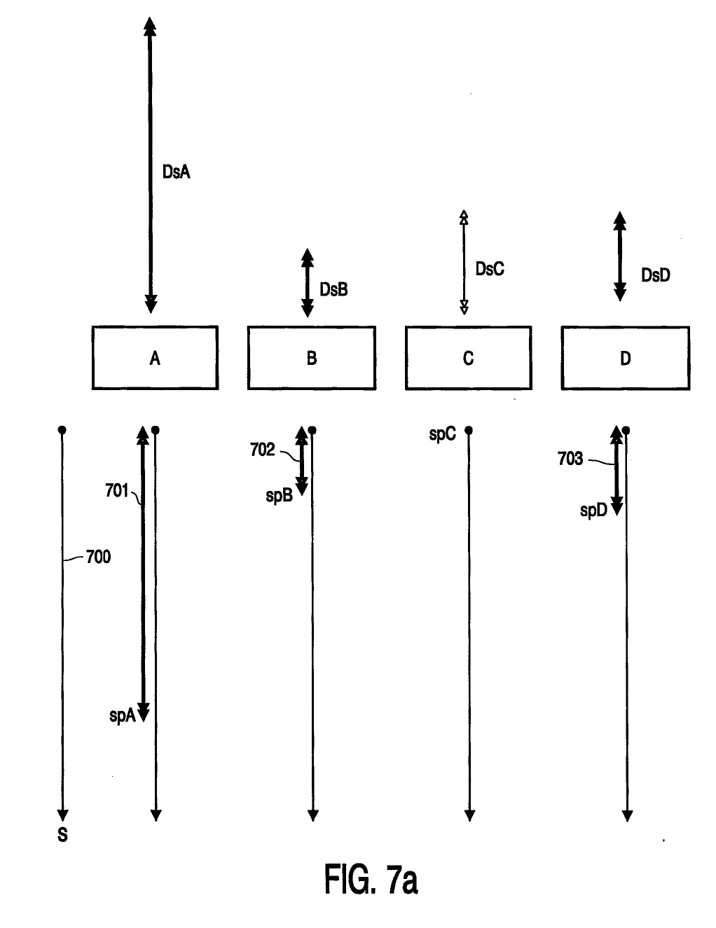

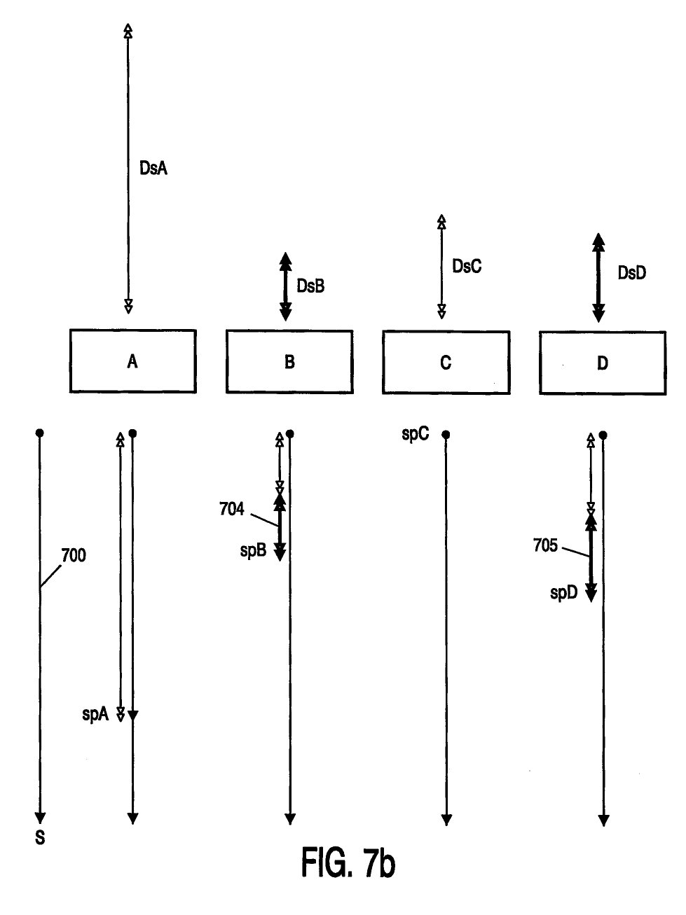

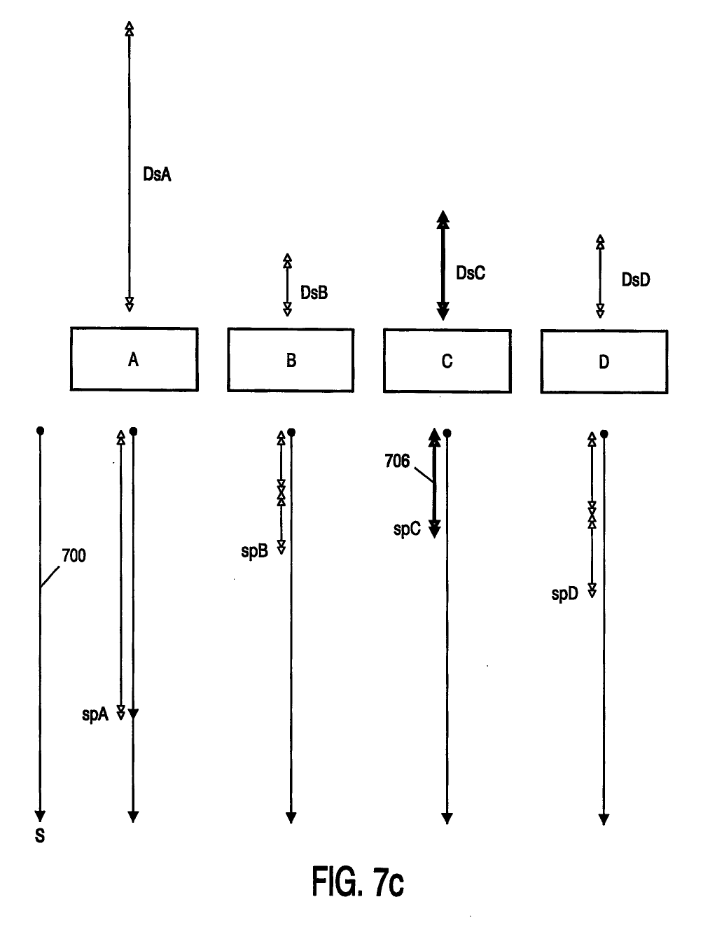

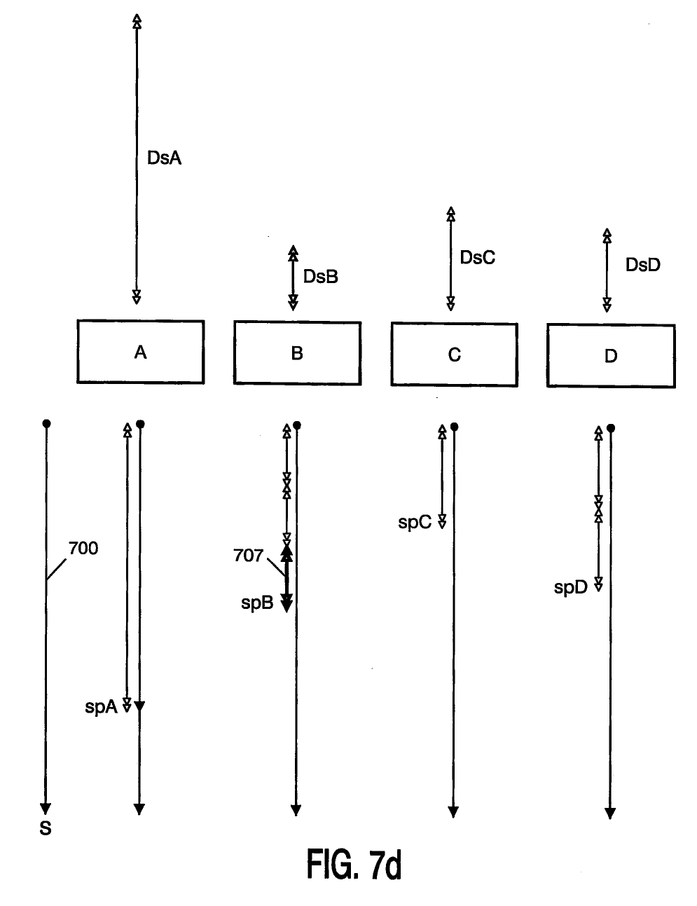

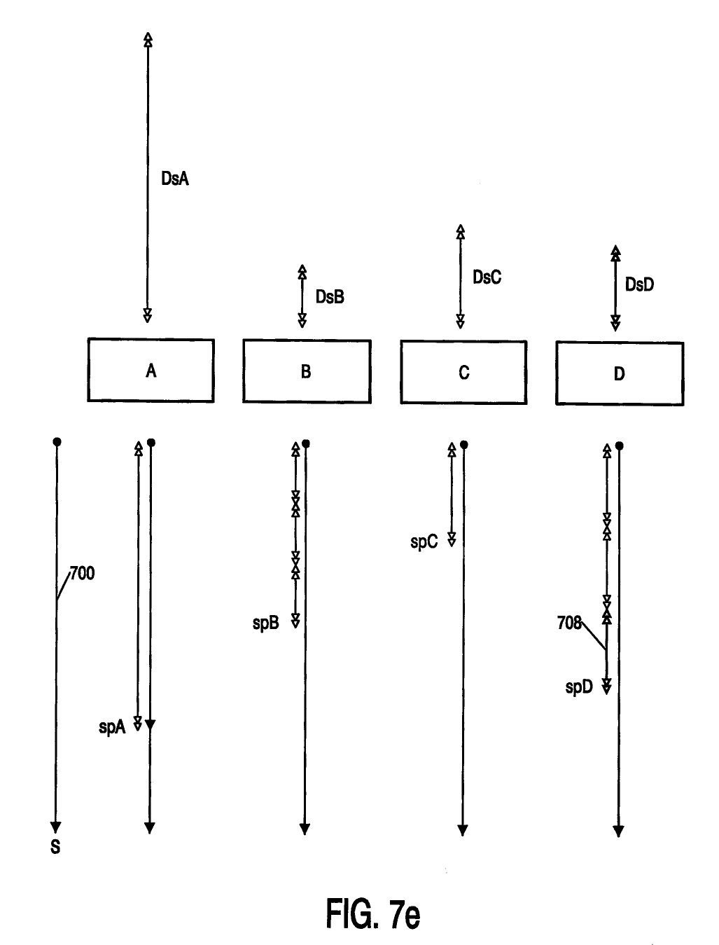

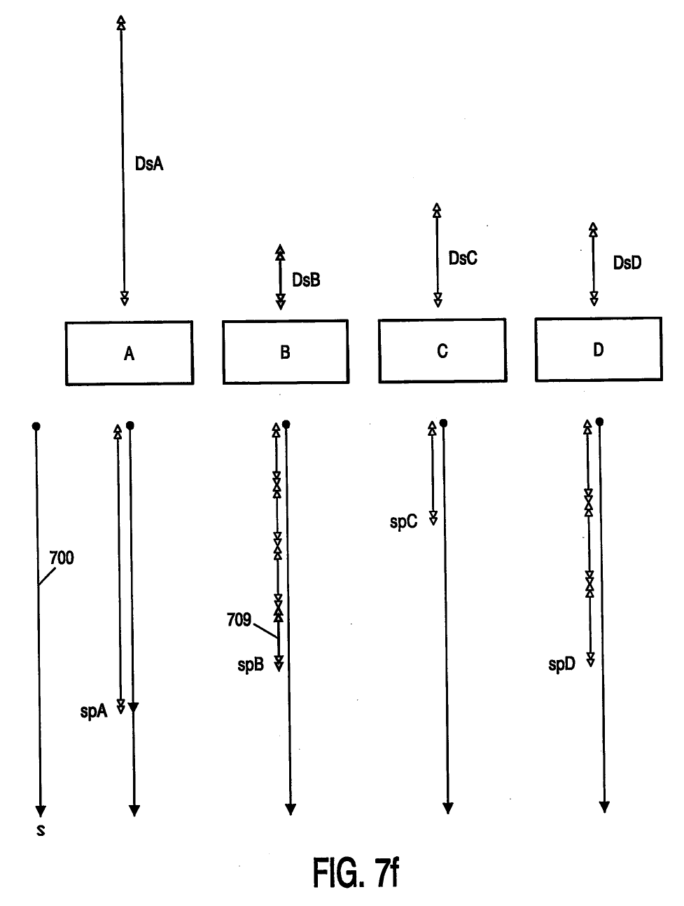

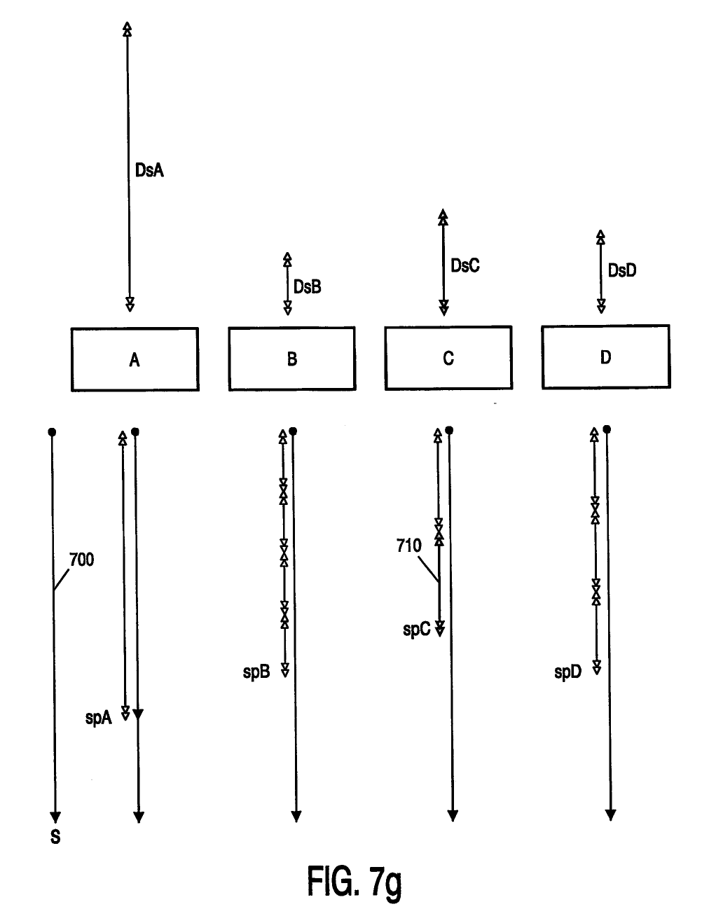

FIG. 7a-7g illustrate the step by step scheduling of the component in the system of FIG. 6.

In the following the present invention will be described being used for time box driven scheduling of software components in hard real-time systems for stream processing. First, time box driven scheduling will be described and this will be followed by a description of how the schedulable components can be scheduled according to the present invention.

A system is an apparatus performing a certain task where the way in which it performs this task can be influenced by management and control. In a preferred embodiment the certain task will be restricted to a hard real-time processing of streaming data. A component is a self-contained part of the system, performing a sub-task that is ‘atomic’, i.e. it is considered not to be useful to subdivide the sub-task any further. The motivation for dividing sub-tasks further or not, is based on experience in the application domain of remultiplexers, encoders and alike. A time stamped data element is a representation of data in a stream. It is supposed that streaming data has data contents and time information. This time information is used to order the elements and to relate the data to time. A time-box is a predefined time interval of time stamped data elements.

Within the system according to the present invention, algorithmic time is used. At the end, the time information generated for the output streams is related to real time again. The conversion from system time to algorithmic time could e.g. be performed by a conventional time filter placed at the system input and system output.

FIG. 1 illustrates a connector between two components; the connector is a self-contained part of the system. A source component 101 is connected to a sink component 103, by a connector 105. The dynamic state of a connector 105 consists of a number of elements on the connector 105 comprising the data elements and the produced-until time sp_{C} (the time until which data has been produced by the source component). Data elements are marked with an algorithmic time sᵢ and can be appended to a connector because of scheduling of the source component at the source side of the connector. Scheduling the source component also updates the produced-until time for the specific connector. The component at the sink side of the connector can remove data elements when it is scheduled, by processing the data elements. For each component a current time box is defined, the time box has a begin time and an end time. In order to schedule a component the time-box has to be full for all connectors at the input of the component, meaning that all data elements with time stamps sᵢ in the time interval between the begin time and the end time of the time-box, are ready/present, or in other words the produced-until time is newer than the end time of the current time box.

FIG. 2 explains in general steps the process of defining scheduleability of components and executing a scheduled component. The process comprises the steps of assigning a time-box to each connector of the component and executing the scheduled component. In 201, a current time-box is assigned to the component. This is done by defining a begin time and an end time of a time interval of the next data elements to be processed by the component. The scheduler could e.g. perform the assigning of a current time-box. When the data elements on a specific connector are ready, meaning that the data elements have been processed by the source component, the data within the current time-box are ready. The current time-box has to be full for each input connector of a component, in order for a component to be schedulable. In 203, the component has been scheduled and the data elements at all connectors, which lie within the bounds of the current time-box, are consumed and processed by the component. The processed data elements are now ready at the output of the component and the produced-until time sp_{C} for each output connector is updated. In 201, a new current time-box is assigned to the component. This is done by defining a new begin time equalling the end time of the previous time-box for the component.

FIG. 3 is a flow diagram illustrating how it is decided whether it is possible to assign a current time box for a specific component. The decision can be made according to two scenarios depending on the type of component. The first type is a Δs component and the second type is a #n component. If the component is a Δs component 301, then it is checked 303 whether the current algorithmic time CS is larger than the begin time BS of the current time box being added a predefined time interval Δs being the length of a time box. The begin time of the current time box equals the end time of the previous time box. If this is true then the time box can be defined and assigned the component 305, if false no time-box !TB can be defined and assigned 307 as sufficient time have not yet passed since the component last processed data elements in a time-box. When the component is a #n component 309, then it is first checked 311 whether there is a predefined number of data elements available on a specific connector #n connector. If this is true then the time box TB can be defined 305 where the begin time is the end time of the previous time-box and the end time is the time stamp of the newest data element available at the specific connector. If it is not true it is checked 313 whether the current algorithmic time is larger than a begin time of a current time box added a displacement value d. If this is true then the data elements are ready and the time box can be defined 305, if the false no time-box !TB can be defined as ??? sufficient data elements is not present yet at the n'th connector. In general Δs components will be able to deal with slightly varying amount of data in their current time-box, while #n-components will take the same amount of data from the input that is specified as the #n connector.

In an embodiment the current time box assigned a component might be displaced in time for each connector as illustrated in FIG. 4. In 401, 1 a component is illustrated having a number of inputs (I1 . . . In) and three outputs (Q1, Q2, Q3). A time-box TB is assigned to the component having a begin time BS and an end time ES as shown by 403. In this example output Q1 has no displacement; Q2 has a positive displacement and Q3 a negative one. The produced-until time for a certain output connector is linked directly to the end-time of the time box by adding the output's displacement:
sp_{cQ}=ES(TB)+ΔdQ
where CQ is the connector attached to output Q of the component, SP_{CQ} produced-until time of connector CQ, se(TB) end time of time box TB with which the component 401 was scheduled and ΔdQ is the displacement of output Q of the component.

Using FIG. 5 it is described how the scheduler uses the time-boxes when determining scheduleability of components. The scheduleability is determined by checking each input connector of the component and if the produced until time sp_{C} for the connector is equal or larger than the end time ES of the time-box of the component, then this connector makes the component qualified to be scheduled 503. Otherwise the component is not ready to be scheduled 505. As mentioned earlier, each input connector of a component has to qualify in order to qualify the component to be scheduled.

It has been described how a component becomes schedulable according to time box driven scheduling and in the following it will be described how to select a component to be scheduled according to an embodiment of the present invention and how the schedulable components are ordered in a flexible priority scheme.

All schedulable components get a flexible priority being based on the point in time that scheduling the component may contribute to an output and the highest priority is given to the component that may contribute the earliest to an output. After each step the set of schedulable components is updated and the priorities of the schedulable components are re-computed. The data is thereby pulled through the graph, where components that contribute earlier to the end result are treated first. If more than one component has highest priority, the push scheduling is applied to them.

One method of calculating the earliest moment in time that a certain component might contribute to the output is by using the path from the component to the output and then calculating the earliest moment in time as the begin time of the new time box subtracted by the time length of all time boxes on the path from the component to the output. By performing this calculation the earliest possible time is calculated. It is supposed that the first time stamped data element in a time box being processed when a component is scheduled, equals a missing time stamped data element in a time box for the next component in the path. The presumption is performed for each component in the path to the output whereby the earliest moment in time that the component might contribute to the output can be found.

When a number of components are schedulable the following formula is used to find which component can contribute to the output at the earliest time and thereby which component to schedule:
Min {spX−ΔsXp|p is a path from component X to an output}
spX is the produced until time of component X equalling the begin time of the current time box of component X and ΔsXp is the sum of the length ?? each predefined time interval associated with each time-box of the components in the path p from component X to the output. In a specific embodiment there might be a time delay and thereby a time displacement in a connection between two or more components in the path. In this case the total displacement ΔdXp along the path p should be subtracted as below:
Min {spX−(ΔsXp−ΔdXp)}

In case two components should be scheduled according to the above, meaning that scheduling these two components could contribute to an output at the same earliest time, then pull scheduling is used to determine which component to schedule.

In FIG. 6 an example of a hard real time system is illustrated being used for explaining the scheduling of schedulable components in the system according to the above. The system consists of 4 components A, B, C and D all being Δs components, where component A is an input component connected via a connector 601 to component B, component B is connected via a connector 603 to component C, being an output component, and component D is an input component being connected via a connector 605 to the output component C. At each connector time-boxes 607, 609, 611 and 613 are illustrated, and together with each time-box time intervals ΔsA, ΔsB, ΔsC, ΔsD are shown illustrating the length of the predefined time interval associated with each time-box. The input components A and D receive a constant stream of data and therefore sufficient data elements are always present to fill the time-box 607 and the time-box 611. This also means that component A and D are always schedulable.

In the following, scheduling of the components A, B, C and D are explained using the FIGS. 7a-7f In all figures each component A, B, C and D is shown together with the time interval ΔsA, ΔsB, ΔsC, ΔsD of the predefined time interval associated to the components A, B, C and D. Further, a time line 700 illustrates the algorithmic time s, and for each component A, B, C, D the produced until time is shown as respectively spA, spB, spC and spD, and according to the general properties of time box scheduling the produced until time for each component equals the begin time of the current time box associated with the component. Initially, the begin time of all time boxes is the same and is marked as a dot.

In FIG. 7a, component A has been scheduled initially, both A and D were schedulable and by using push scheduling A was chosen.

Data elements in the time interval 701 have been processed by component A and the produced until time spA has increased. After having scheduled component A sufficient data are available to schedule component A, component B and component D. Which component to schedule is determined by the calculations resulting in the minimum number or earliest time:
Component A: spA−(ΔsB+ΔsC)
Component B: spB−ΔsC
Component D: spD−ΔsC

In this case both B and D can contribute to the output at the same earliest time and therefore push scheduling is used and Component B is scheduled.

After having scheduled component B illustrated by the time interval 702 at the time axis of B, the produced until time spB increases. Sufficient data are available to schedule component A, component B and component D. Which component to schedule is determined by the calculations resulting in the minimum number or earliest time:
Component A: spA−(ΔsB+ΔsC)
Component B: spB−ΔsC
Component D: spD−ΔsC

Component D can contribute to the output at the earliest time and therefore component D is scheduled as illustrated by the time interval 703. At the time axis of D the produced until time spD increases.

In FIG. 7b sufficient data are still only available to schedule component A, B and D. Which component to schedule is determined by the calculations resulting in the minimum number or earliest time:
Component A: spA−(ΔsB+ΔsC)
Component B: spB−ΔsC
Component D: spD−ΔsC

This time component B can contribute to the output at the earliest time and therefore component B is scheduled as illustrated by the time interval 704.

Then again component A, B and D can be scheduled and by using the above calculations component D is scheduled again as illustrated by the time interval 705.

As illustrated in FIG. 7c sufficient data are now available to schedule component C and therefore both component A, B, C and D are schedulable. Which component to schedule is determined by the calculations resulting in the minimum number or earliest time:
Component A: spA−(ΔsB+ΔsC)
Component B: spB−ΔsC
Component D: spD−ΔsC
Component C: spC

Component C can contribute to the output at the earliest time and therefore component C is scheduled as illustrated by the time interval 706.

As seen from FIG. 7d, sufficient data are now only available to schedule component A, B and D making those components schedulable. Which component to schedule is determined by the calculations resulting in the minimum number or earliest time:
Component A: spA−(ΔsB+ΔsC)
Component B: spB−ΔsC
Component D: spD−ΔsC

Component B can contribute to the output at the earliest time and therefore component B is scheduled as illustrated by the time interval 707.

In FIG. 7e, sufficient data are available to schedule component A, B and D making those components schedulable. Which component to schedule is determined by the calculations resulting in the minimum number or earliest time:
Component A: spA−(ΔsB+ΔsC)
Component B: spB−ΔsC
Component D: spC−ΔsC

Component D can contribute to the output at the earliest time and therefore component D is scheduled as illustrated by the time interval 708.

In FIG. 7f, sufficient data are available to schedule component A, B and D making those components schedulable. Which component to schedule is determined by the calculations resulting in the minimum number or earliest time:
Component A: spA−(ΔsB+ΔsC)
Component B: spB−ΔsC
Component D: spD−ΔsC

Component B can contribute to the output at the earliest time and therefore component B is scheduled as illustrated by the time interval 709.

As illustrated in FIG. 7g sufficient data are now available to schedule component C and therefore both component A, B, C and D are schedulable. Which component to schedule is determined by the calculations resulting in the minimum number or earliest time:
Component A: SpA−(ΔsB+ΔsC)
Component B: SpB−ΔsC
Component D: SpD−ΔsC
Component C: SpC

Component C can contribute to the output at the earliest time and therefore component C is scheduled as illustrated by the time interval 710.

The scheduling can continue similar to the above.

1. A method of scheduling schedulable component in a hard real time system for processing time dependent streams of data elements, where the number of schedulable components is larger than the number of available processors for processing said components and where each of said components has at least one input and one output characterized in that the method comprises the steps of consecutively:
determining for each schedulable component the earliest time on which said component can contribute to the output of said hard real time system,
scheduling the schedulable component that can contribute to the output of said real time system at the total earliest time.

2. A method according to claim 1, wherein if a number of schedulable components contribute to the output of said real time system at the same total earliest time, then scheduling of said number of components is performed using push scheduling.

3. A method according to claim 1, wherein a length of a predefined time interval is specified for each component and a component is schedulable when time stamped data elements from said predefined time interval of said time dependent stream of time stamped data element is available at all inputs of said component.

4. A method according to claim 3, wherein the availability of said predefined time interval of said time stamped data elements is determined by defining a begin time and an end time of said predefined time interval and checking when the time, until which data has been processed by a preceding component, is newer than the end time of said predefined time interval.

5. A method according to claim 3 wherein the step of determining the earliest time on which said component can contribute to the output is performed by:
identifying possible paths of subsequent components that the data elements have to be processed by in order to reach the output of said system from said component,
determining an earliest contribution time for each possible path by subtracting from the begin time of said predefined time interval the length of each of the predefined time intervals specified for each of said subsequent components in said path.
determining the earliest time on which said component can contribute to the output as the earliest determined contribution time.

6. A method according to claim 3, wherein the step of determining the earliest time on which said component can contribute to the output is performed by:
identifying a path of subsequent components that the data elements have to be processed by in order to reach the output of said system from said component,
determining an earliest contribution time for each possible path by subtracting from the begin time of said predefined time interval, the length of each of the predefined time intervals specified for each of said subsequent components in said path, where at least some of said predefined time intervals have been subtracted a displacement value.
determining the earliest time on which said component can contribute to the output as the earliest determined contribution time.

7. A hard real time system for processing time dependent streams of data elements, said system comprising a number of components and a number of processors for processing components, said number of components is larger than the number of processors, each of said components having at least one input and at least one output, said system comprises means for determining for each schedulable component the earliest time on which said component can contribute to the output of said hard real time system, and means for scheduling the schedulable component that can contribute to the output of said real time system at the total earliest time.
